(19) United States
(12) Patent Application Publication
(10) Pub. No.: US 2022/0209379 A1
(43) Pub. Date: Jun. 30, 2022

(54) PHASE CONTROL STRUCTURE AND PHASE CONTROL ARRAY

(71) Applicant: INDUSTRIAL TECHNOLOGY RESEARCH INSTITUTE, Hsinchu (TW)

(72) Inventor: Yueh-Lin TSAI, Yunlin County (TW)

(73) Assignee: INDUSTRIAL TECHNOLOGY RESEARCH INSTITUTE, Hsinchu (TW)

(21) Appl. No.: 17/135,492

(22) Filed: Dec. 28, 2020

(51) Int. Cl. H01P 1/18

(52) U.S. Cl. CPC H01P 1/18; H01Q 3/36

(57) ABSTRACT

A phase control structure includes a metal electrode plate, a stub portion, a switch and a ground plate. The metal electrode plate includes a first surface and a second surface, and one end of the stub portion is connected to the second surface. The metal electrode plate and the ground plate are disposed on a top surface and a bottom surface of a substrate, respectively. The substrate is disposed with a via hole. The second surface of the metal electrode plate contacts the top surface of the substrate. The stub portion is disposed in the via hole without contacting the ground plate. One end of the switch is connected to another end of the stub portion, and the ground plate is connected to another end of the switch. The switch is configured to receive a control signal to be one of an on state and an off state.

This disclosure relates to a phase control structure and a phase control array of an antenna.

### BACKGROUND

The traditional polarization array antenna must regulate the reflection phase difference of each phase antenna unit through a phase shifter, so as to achieve the purpose of beam concentration or beam scanning. The final use needs usually to increase the antenna gain, however, when the antenna gain is increased, it is relatively necessary to increase the number of phase shifters, thereby leading to higher costs. In view of the above problems, researchers try to replace the function of the traditional phase shifters with an adjustable surface impedance plane. The method of the adjustable surface impedance plane for regulating reflection phase is to add a variable capacitor between two adjacent metal electrode plates of the adjustable surface impedance plane, and change the resonance frequency by changing the capacitance value of the variable capacitor, to achieve the purpose of changing the reflection phase. However, the current adjustable surface impedance plane has a phase difference range of up to 300 degrees, and there is still room for improvement.

In one of research topics, there are indeed an improved phase control structure and the phase control array thereof in order to improve the above disadvantages.

### SUMMARY

According to one embodiment of this disclosure, a phase control structure includes a metal electrode plate, a stub portion, a switch, and a ground plate. The metal electrode plate includes a first surface and a second surface, and one end of the stub portion is connected to the second surface of the metal electrode plate. The metal electrode plate and the ground plate are respectively disposed on a top surface and a bottom surface of a substrate. The substrate is disposed with a via hole extending from the top surface of the substrate to the bottom surface of the ground plate. The second surface of the metal electrode plate contacts the top surface of the substrate. The stub portion is disposed in a via hole without contacting the ground plate. One end of the switch is connected to another end of the stub portion. The ground plate is connected to another end of the switch. The switch is used to receive a control signal to be in one of an on state and an off state.

According to one embodiment of this disclosure, a phase control array includes a plurality of phase control structures and a plurality of diodes. Each of the plurality of phase control structures includes a metal electrode plate, a stub portion, a switch and a ground plate. The metal electrode plate includes a first surface and a second surface, and one end of the stub portion is connected to the second surface. Another end of the stub portion is connected to one end of the switch, and another end of the switch is connected to the ground plate. The metal electrode plate and the ground plate are disposed on a top surface and a bottom surface of a substrate respectively. The substrate is disposed with a via hole extending from the top surface of the substrate to the bottom surface of the ground plate. The second surface of the metal electrode plate contacts the top surface of the substrate. The stub portion is disposed in the via hole without contacting the ground plate. The switch is used to receive a control signal to be in one of an on state and an off state. A plurality of metal electrode plates of the phase control structures are spaced apart from each other, and each of the plurality of diodes is connected between any two adjacent metal electrode plates of the plurality of metal electrode plates.

According to one embodiment of this disclosure, a phase control array includes a plurality of phase control structures and a plurality of variable capacitors. Each phase control structure includes a metal electrode plate, a stub portion, a switch and a ground plate. The metal electrode plate includes a first surface and a second surface, and one end of the stub portion is connected to the second surface. Another end of the stub portion is connected to one end of the switch, and another end of the switch is connected to the ground plate. The metal electrode plate and the ground plate are disposed on a top surface and a bottom surface of a substrate respectively. The substrate is disposed with a via hole extending from the top surface of the substrate to the bottom surface of the ground plate. The second surface of the metal electrode plate contacts the top surface of the substrate. The stub portion is disposed in the via hole without contacting the ground plate. The switch is used to receive a control signal to be in one of an on state and an off state. A plurality of metal electrode plates of the phase control structures are spaced apart from each other, and each of the plurality of variable capacitors is connected between any two adjacent metal electrode plates of the plurality of metal electrode plates.

The above description of the summary and the description of the following embodiments are provided to illustrate and explain the spirit and principles of this disclosure, and to provide further explanation of the scope of this disclosure.

### BRIEF DESCRIPTION OF THE DRAWINGS

FIG. 1 is a top view of a first embodiment of a phase control structure.

FIG. 2 is a side view of the first embodiment of the phase control structure.

FIG. 3 is a top view of a second embodiment of the phase control structure.

FIG. 4 is a side view of the second embodiment of the phase control structure.

FIG. 5 is a top view of a third embodiment of the phase control structure.

FIG. 6 is a side view of the third embodiment of the phase control structure.

FIG. 7 is a top view of a phase control array applying the first embodiment of the phase control structure.

FIG. 8 is a partial side view of the phase control array applying the first embodiment of the phase control structure.

FIG. 9 is a top view of the phase control array applying the second embodiment of the phase control structure.

FIG. 10 is a partial side view of the phase control array applying the second embodiment.

FIG. 11 is a top view of the phase control array applying the third embodiment of the phase control structure.

FIG. 12 is a partial side view of the phase control array applying the third embodiment of the phase control structure.

FIG. 13 is a top view of another embodiment of the phase control array.

FIG. 14 is a partial side view of the phase control array of FIG. 13.

FIG. 15 is a diagram of the relationship between phase and frequency of an embodiment of the phase control structure.

### DETAILED DESCRIPTION

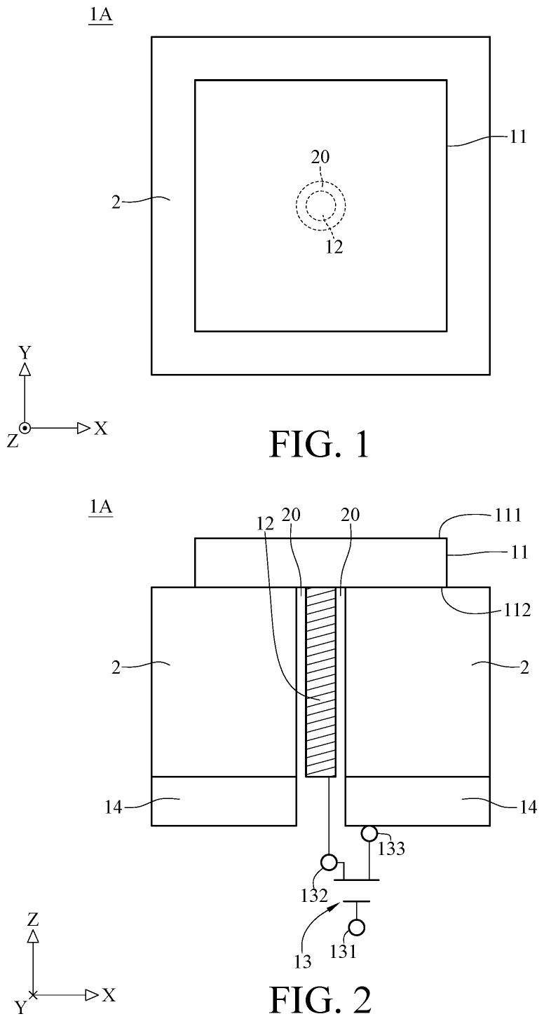

FIG. 1 is a top view of the first embodiment of the phase control structure 1A, and FIG. 2 is a side view of the first embodiment of the phase control structure 1A. As shown in FIG. 1 and FIG. 2, the phase control structure 1A includes a metal electrode plate 11, a stub portion 12, a switch 13 and a ground plate 14. The metal electrode plate 11 and the ground plate 14 are respectively disposed on the top surface of the substrate 2 and the bottom surface of the substrate 2. The substrate 2 is, for example, a printed circuit board, and a via hole 20 extends from the top surface of the substrate 2 along the Z-axis direction to the bottom surface of the ground plate 14. The metal electrode plate 11 includes a first surface 111 and a second surface 112, and the second surface 112 of the metal electrode plate 11 is used to contact the top surface of the substrate 2 and to shield the via hole 20. The stub portion 12 is used to be disposed in the via hole 20 without contacting the ground plate 14, and the upper end of the stub portion 12 is connected to the second surface 112 of the metal electrode plate 11. The stub portion 12 may contact the side wall of the via hole 20 or may not contact the side wall of the via hole 20. In the following embodiments, the stub portion 12 does not contact the side wall of the via hole 20 is taken as an example. The switch 13 includes a control terminal 131, an input terminal 132 and an output terminal 133. The control terminal 131 is used to receive one or more control signals. The input terminal 132 is connected to the lower end of the stub portion 12, and the output terminal 133 of the switch 13 is connected to the ground plate 14. The switch 13 is used to be one of the on state and the off state according to a received control signal. When the voltage value of the received control signal is higher than the critical threshold of the switch, the switch 13 is in the on state, and the stub portion 12 is electrically connected to the ground plate 14 through the switch 13. When the voltage value of the received control signal does not reach the critical threshold value, the switch 13 is in the off state, and the stub portion 12 fail to be electrically connected to the ground plate 14 through the switch 13. In this embodiment, the switch 13 may be but not limited to a MOS transistor.

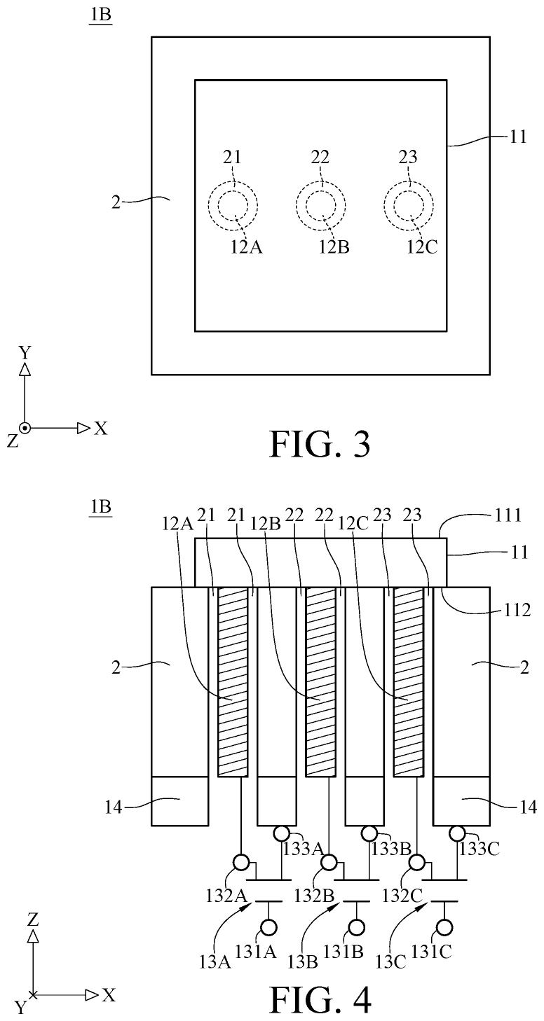

FIG. 3 is a top view of the second embodiment of the phase control structure 1B, and FIG. 4 is a side view of the second embodiment of the phase control structure 1B. As shown in FIG. 3 and FIG. 4, the main difference between the phase control structure 1B and the phase control structure 1A is the number of stub portions and the number of switches. In the second embodiment, the phase control structure 1B includes a first stub portion 12A, a second stub portion 12B, a third stub portion 12C, a first switch 13A, a second switch 13B, and a third switch 13C. A first via hole 21, a second via hole 22, and a third via hole 23 respectively extend from the top surface of the substrate 2 along the Z-axis direction to the bottom surface of the ground plate 14, and the second via hole 22 is spaced apart from the first via hole 21 and the third via hole 23 along the X-axis direction. The second via hole 22 is located between the first via hole 21 and the third via hole 23, and the substrate 2 is disposed with insulating dielectric materials between the first via hole 21 and the second via hole 22 respectively.

As shown in FIG. 3 and FIG. 4, the second surface 112 of the metal electrode plate 11 shields the first via hole 21, the second via hole 22 and the third via hole 23. The first stub portion 12A, the second stub portion 12B, and the third stub portion 12C are respectively disposed in the first via hole 21, the second via hole 22, and the third via hole 23. These stub portions 12A, 12B and 12C are not in contact with the ground plate 14. The upper end of the first stub portion 12A, the upper end of the second stub portion 12B, and the upper end of the third stub portion 12C are respectively connected to the second surface 112 of the metal electrode plate 11. The second stub portion 12B is spaced apart from the first stub portion 12A and the third stub portion 12C along a direction (the X-axis direction).

The first switch 13A includes a first control terminal 131A, a first input terminal 132A, and a first output terminal 133A. The first control terminal 131A is used to receive a first control signal, and the first input terminal 132A is connected to a lower end of the first stub portion 12A, and the first output end 133A is connected to the ground plate 14. When the voltage value of the first control signal is higher than a critical threshold value of the first switch 13A, the first switch 13A is in the on state, and the first stub portion 12A can be electrically connected the ground plate 14 through the first switch 13A. Conversely, when the voltage value of the first control signal is lower than the critical threshold of the first switch 13A, the first switch 13A is in the off state, and the first stub portion 12A fails to be electrically connected to the ground plate 14 through the first switch 13A.

The second switch 13B includes a second control terminal 131B, a second input terminal 132B, and a second output terminal 133B. The second control terminal 131B is used to receive a second control signal, and the second input terminal 132B is connected to the lower end of the second stub portion 12B, and the second output end 133B is connected to the ground plate 14. When the voltage value of the second control signal is higher than a critical threshold of the second switch 13B, the second switch 13B is in the on state, and the second stub portion 12B can be electrically connected to the ground plate 14 through the second switch 13B. Conversely, when the voltage value of the second control signal is lower than the critical threshold of the second switch 13B, the second switch 13B is in the off state, and the second stub portion 12B fails to be electrically connected to the ground plate 14 through the second switch 13B.

The third switch 13C includes a third control terminal 131C, a third input terminal 132C, and a third output terminal 133C. The third control terminal 131C is used to receive a third control signal, and the third input terminal 132C is connected to the lower end of the third stub portion 12C, and the third output end 133C are connected to the ground plate 14. When the voltage value of the third control signal is higher than the critical threshold of the third switch 13C, the third switch 13C is in the on state, and the third stub portion 12C can be electrically connected to the ground plate 14 through the third switch 13C. Conversely, when the voltage value of the third control signal is lower than the critical threshold of the third switch 13C, the third switch 13C is in the off state, and the third stub portion 12C fails to be electrically connected to the ground plate 14 through the third switch 13C.

For example, when the first switch 13A is in the on state, the second switch 13B is in the off state, and the third switch 13C is in the on state, An current conduction path can be formed through the first stub portion 12A, the ground plate 14 and the third stub portion 12C, and the length of the current conduction path is related to the inductance value of the phase control structure 1B.

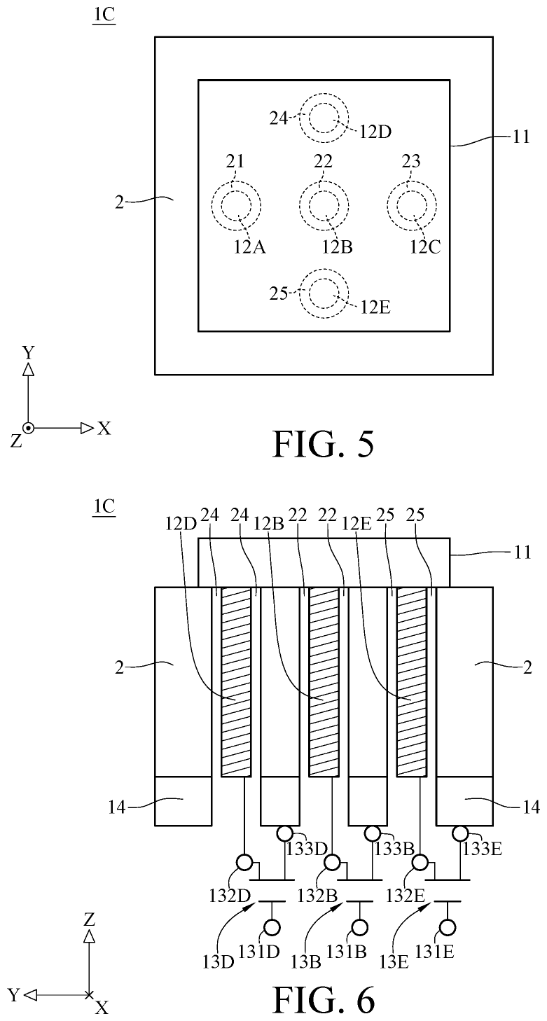

FIG. 5 is a top view of the third embodiment of the phase control structure 1C, and FIG. 6 is a side view of the phase control structure 1C. As shown in FIG. 5 and FIG. 6, the main difference between the phase control structure 1C and the phase control structure 1B is that the phase control structure 1C in the third embodiment further includes a fourth stub portion 12D, a fifth stub portion 12E, a fourth switch 13D and a fifth switch 13E. A fourth via hole 24 and a fifth via hole 25 respectively extend from the top surface of the substrate 2 along the Z-axis direction to the bottom surface of the ground plate 14, and the second via hole 22 is spaced apart from the fourth via hole 24 and the fifth via hole 25 along the Y-axis direction. The second via hole 22 is located between the fourth via hole 24 and the fifth via hole 25, and the substrate 2 is disposed respectively with insulating dielectric materials between the second via hole 22 and the fourth via hole 24, and between the second via hole 22 and the fifth via hole 25.

As shown in FIG. 5 and FIG. 6, the second surface 112 of the metal electrode plate 11 further shields the fourth via hole 24 and the fifth via hole 25, and the fourth stub portion 12D and the fifth stub portion 12E are respectively disposed in the fourth via hole 24 and the fifth via hole 25. The fourth stub portion 12D and the fifth stub portion 12E are not in contact with the ground plate 14, and the upper end portion of the fourth stub portion 12D and the upper end portion of the fifth stub portion 12E are respectively connected to the second surface 112 of the metal electrode plate 11. The fourth stub portion 12D is spaced apart from the second stub portion 12B and the fifth stub portion 12E along a direction (the Y-axis direction). The Y-axis direction is perpendicular to the X-axis direction.

The fourth switch 13D includes a fourth control terminal 131D, a fourth input terminal 132D, and a fourth output terminal 133D. The fourth control terminal 131D is used to receive a fourth control signal, and the fourth input terminal 132D is connected to the lower end of the fourth stub portion 12D, and the fourth output end 133D is connected to the ground plate 14. When the voltage value of the fourth control signal is higher than the critical threshold of the fourth switch 13D, the fourth switch 13D is in the on state, and the fourth stub portion 12D can be electrically connected to the ground plate 14 through the fourth switch 13D. Conversely, when the voltage value of the fourth control signal is lower than the critical threshold value of the fourth switch 13D, the fourth switch 13D is in the off state, and the fourth stub portion 12D fails to be electrically connected to the ground plate 14 through the fourth switch 13D.

The fifth switch 13E includes a fifth control terminal 131E, a fifth input terminal 132E, and a fifth output terminal 133E. The fifth control terminal 131E is used to receive a fifth control signal, and the fifth input terminal 132E is connected to the lower end of the fifth stub portion 12E, and the fifth output end 133E is connected to the ground plate 14. When the voltage value of the fifth control signal is higher than the critical threshold of the fifth switch 13E, the fifth switch 13E is in the on state, and the fifth stub portion 12E can be electrically connected to the ground plate 14 through the fifth switch 13E. Conversely, when the voltage value of the fifth control signal is lower than the critical threshold of the fifth switch 13E, the fifth switch 13E is in the off state, and the fifth stub portion 12E fails to be electrically connected to the ground plate 14 through the fifth switch 13E.

For example, when the second switch 13B is in the off state, the fourth switch 13D is in the on state, and the fifth switch 13E is in the on state, the current conduction path can be formed through the fourth stub portion 12D, the ground plate 14 and the fifth stub portion 12E, and the length of the current conduction path is related to the inductance value of the phase control structure 1C.

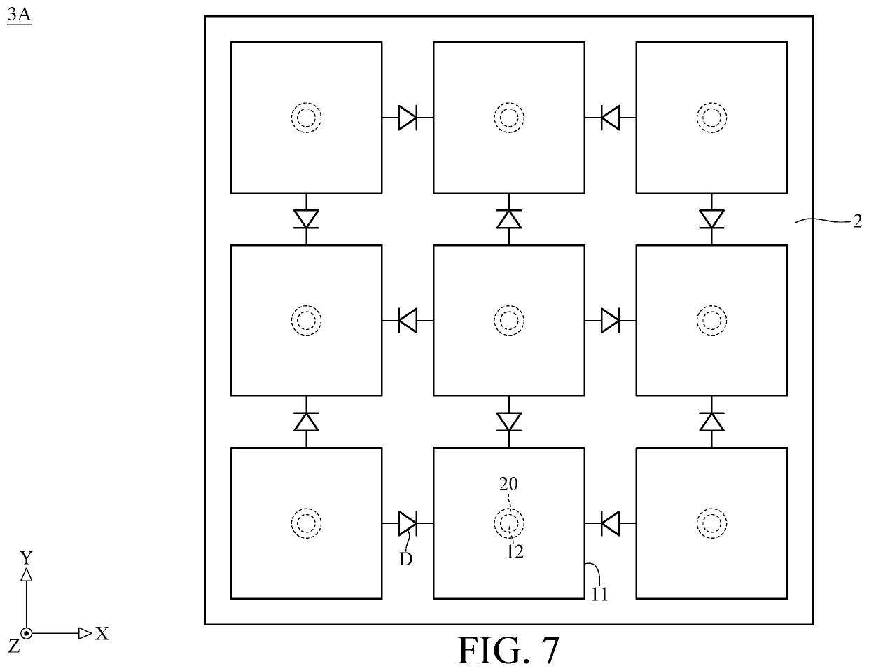

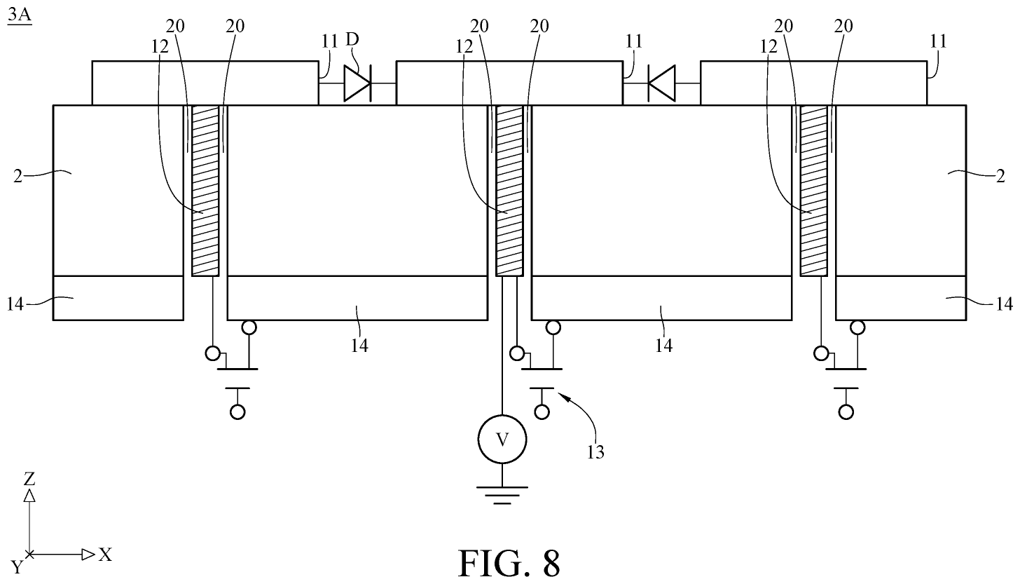

FIG. 7 is a top view of the phase control array 3A applying the embodiment of the phase control structure 1A, and FIG. 8 is a partial side view of the phase control array 3A. As shown in FIG. 7, the phase control array 3A includes a plurality of metal electrode plates 11, a plurality of stub portion 12, a plurality of switch 13, the ground plate 14 and a plurality of diodes D. These metal electrode plates 11 of the phase control structure 1A are spaced apart and arranged in an array form of three columns (X-axis direction) and three rows (Y-axis direction), and each diode D is connected between any two adjacent metal electrode plates 11. In other embodiments, in addition to the quadrilateral shown in FIG. 7, the shape of the arrangement of the metal electrode plates 11 may also be a hexagon. When the shape of the arrangement of the metal electrode plates 11 is a hexagon, the position relationship between any two metal electrode plates 11 in the phase control array is relatively changed. As shown in FIG. 8, the lower end of one stub portion 12 of the phase control array 3A is used to connect an external power source V. By controlling the voltage value of the external power supply V connected to the stub portion 12, the diode D connected between the two adjacent metal electrode plates 11 is in off state. In this way, a capacitance effect will be formed between two adjacent metal electrode plates 11. Furthermore, by changing the voltage value of the external power supply V, the capacitance value between two adjacent metal electrode plates 11 can be changed. In addition, by controlling each switch 13 of the phase control structure 1A in the phase control array 3A to be in one of the on state and the off state, the equivalent inductance value of the phase control array 3A can be controlled. Since both the capacitance value and the inductance value of the phase control array 3A of the present disclosure are controllable, more resonance frequencies of different combinations can be generated according to application requirements, and the range of phase change and the usable bandwidth are also increased.

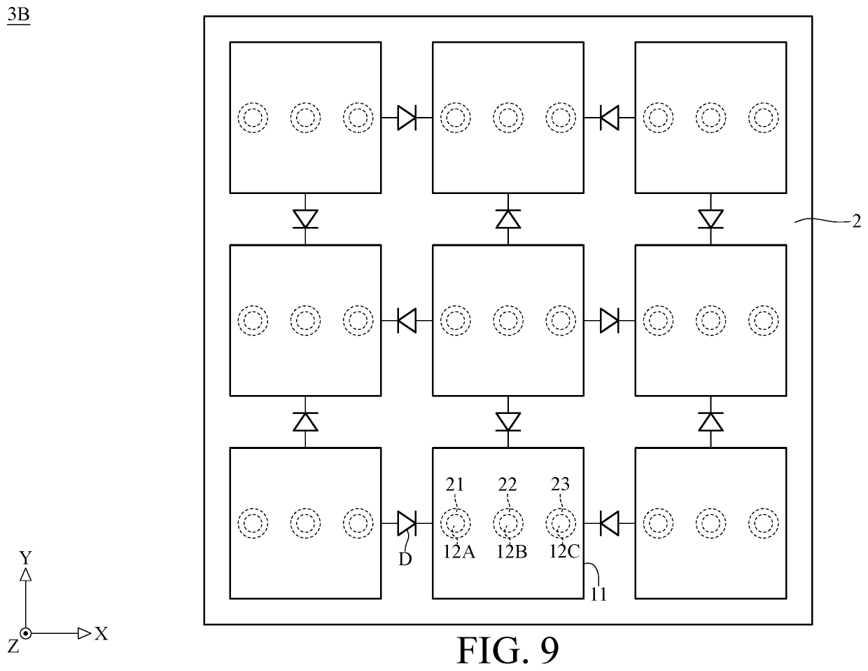

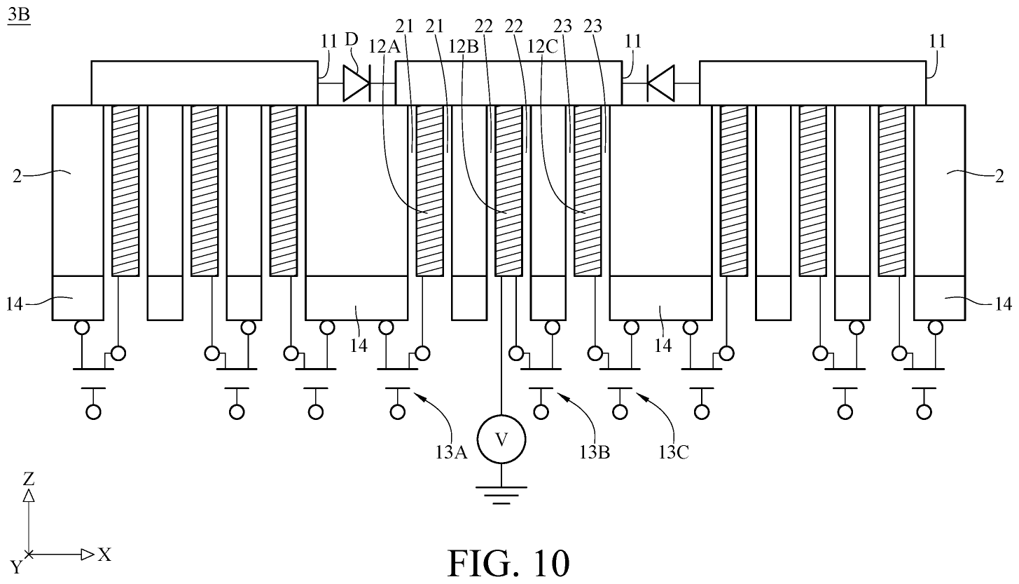

FIG. 9 is a top view of the phase control array 3B applying the embodiment of the phase control structure 1B, and FIG. 10 is a partial side view of the phase control array 3B. As shown in FIG. 9 and FIG. 10, the phase control array 3B includes a plurality of metal electrode plates 11, a plurality of stub portions 12A, 12B and 12C, a plurality of switches 13A, 13B and 13C, the ground plate 14 and a plurality of diodes D. The plurality of metal electrode plates 11 are spaced apart and arranged in an array form of three columns (X-axis direction) and three rows (Y-axis direction), and each diode D is connected between any two adjacent metal electrode plates 11. As shown in FIG. 10, the lower end of one stub portion (such as 12 B) of the phase control array 3B is used to connect an external power source V. By controlling the voltage value of the external power supply V connected to the stub portion 12B, the diode D connected between the two adjacent metal electrode plates 11 is in off state. In this way, a capacitance effect will be formed between two adjacent metal electrode plates 11. Furthermore, by changing the voltage value of the external power supply V, the capacitance value between two adjacent metal electrode plates 11 can be changed. Furthermore, by changing the voltage value of the external power supply V, the capacitance value between two adjacent metal electrode plates 11 can be changed. By controlling each of the first switch 13A, the second switch 13B, and the third switch 13C in the phase control array 3B to be in one of the on state and the off state, the equivalent inductance value of the phase control array 3B can be controlled.

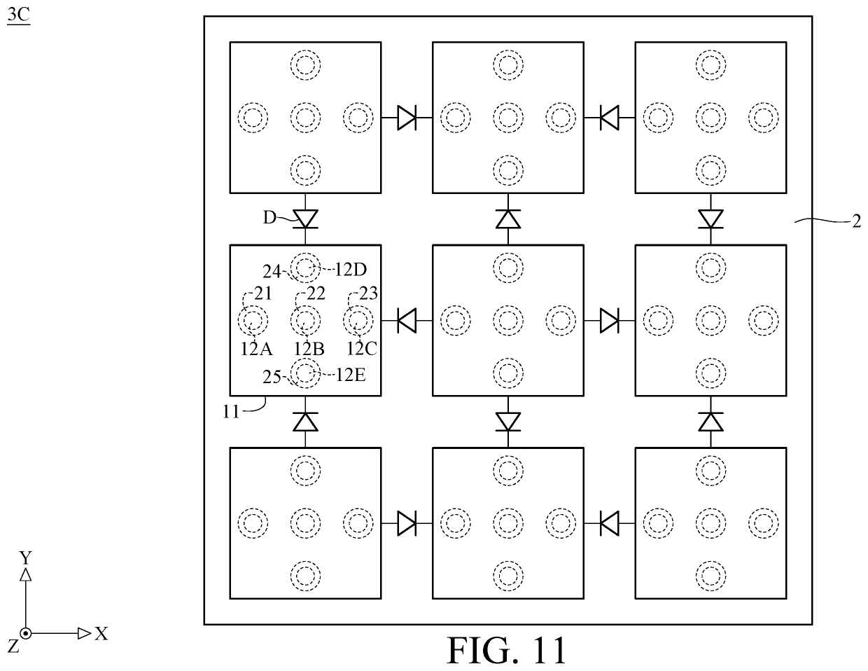

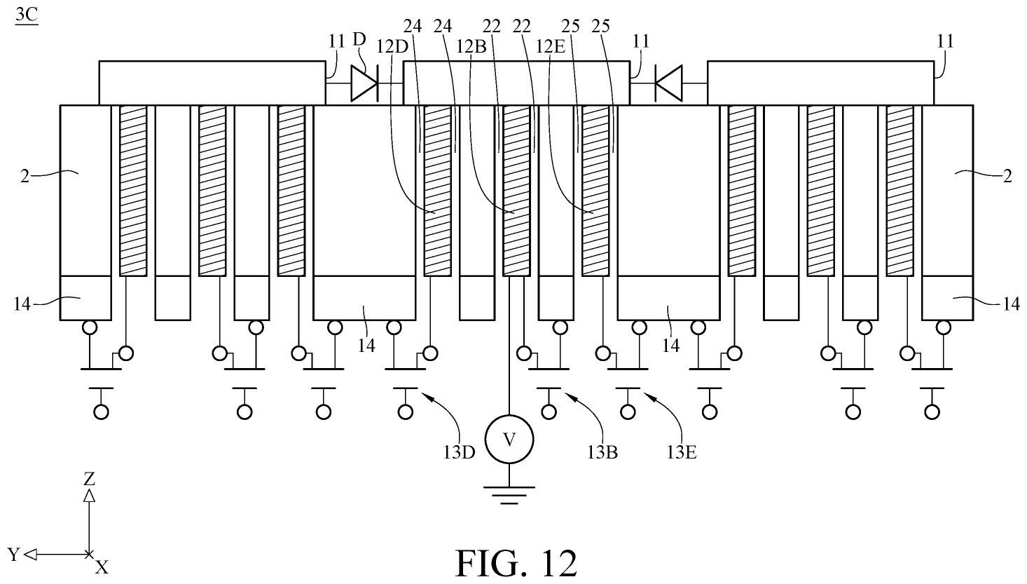

FIG. 11 is a top view of the phase control array 3C applying the embodiment of the phase control structure 1C, and FIG. 12 is a partial side view of the phase control array 3C. As shown in FIG. 11 and FIG. 12, the phase control array 3C includes a plurality of metal electrode plates 11, a plurality of stub portions 12A, 12B, 12C, 12D and 12E, a plurality of switches 13A, 13B, 13C, 13D and 13E, the ground plate 14 and a plurality of diodes D. The plurality of metal electrode plates 11 are spaced apart and arranged in an array form of three columns (X-axis direction) and three rows (Y-axis direction), and each diode D is connected between any two adjacent metal electrode plates 11. As shown in FIG. 12, the lower end of one stub portion (12B, as an example) of the phase control array 3C is used to connect an external power source V. By controlling the voltage value of the external power supply V connected to the stub portion 12B, the diode D connected between the two adjacent metal electrode plates 11 is in off state. In this way, a capacitance effect will be formed between two adjacent metal electrode plates 11. Furthermore, by changing the voltage value of the external power supply V, the capacitance value between two adjacent metal electrode plates 11 can be changed. Furthermore, by changing the voltage value of the external power supply V, the capacitance value between two adjacent metal electrode plates 11 can be changed. By controlling each of the first switch 13A, the second switch 13B, and the third switch 13C in the phase control array 3C to be in one of the on state and the off state, the equivalent inductance value of the phase control array 3B can be controlled.

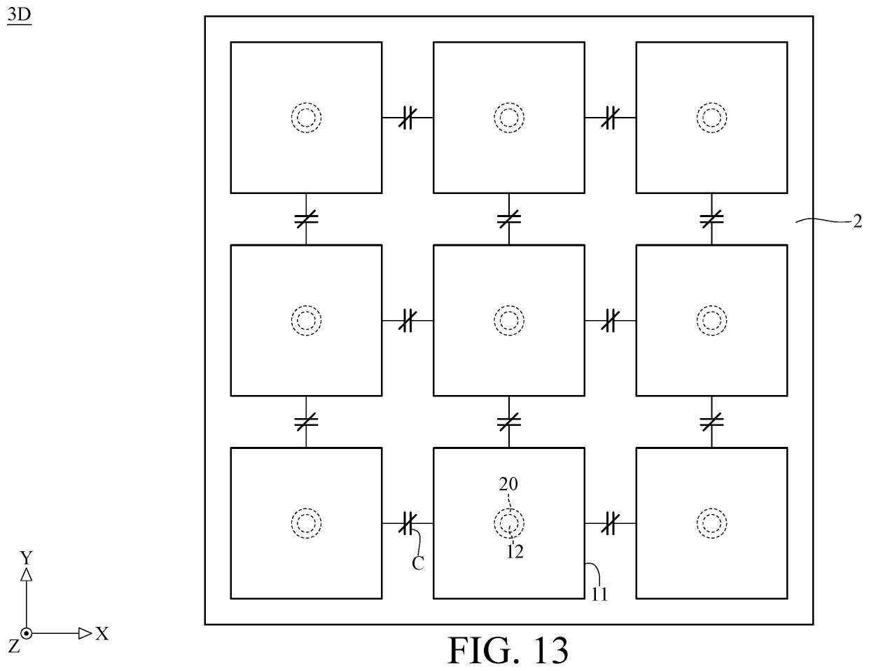

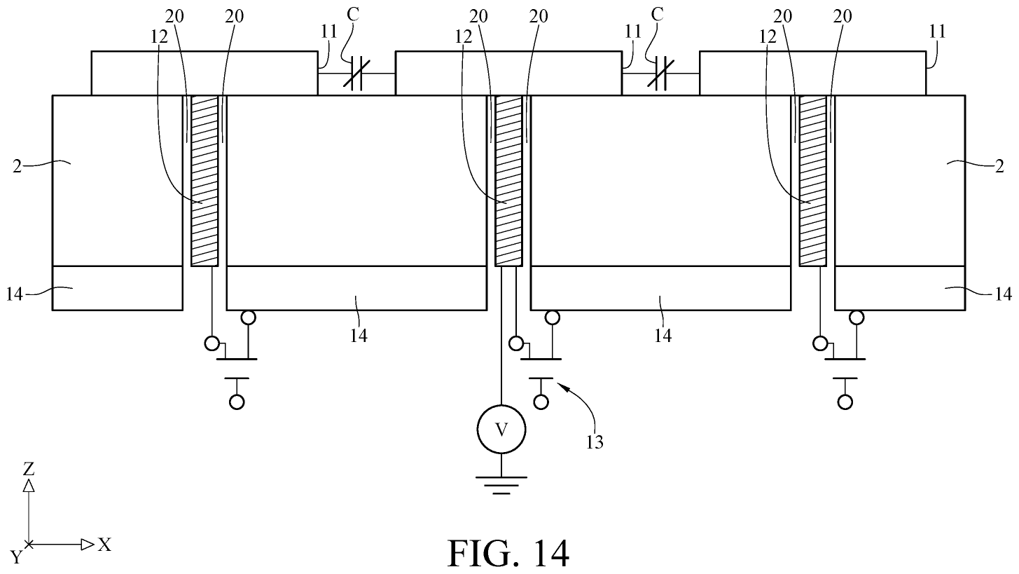

FIG. 13 is a top view of another embodiment of the phase control array 3D, and FIG. 14 is a partial side view of the phase control array 3D of FIG. 13. Compared with FIG. 13 and FIG. 7, the phase control array 3D of FIG. 13 replaces all the diodes D in the phase control array 3A of FIG. 7 with a variable capacitor C. As shown in FIG. 13 and FIG. 14, by controlling the voltage value of the external power supply V connected to the stub portion 12 of the phase control structure 1A, the equivalent capacitance value of the phase control array 3D can be controlled. The controlling method of the equivalent inductance value of the phase control array 3D is the same with the controlling method of the equivalent inductance value of the phase control array 3A in FIG. 7.

In yet another embodiment of the phase control array, each diode D in the phase control array 3B of FIG. 9 is replaced with a variable capacitor C.

In yet another embodiment of the phase control array, each diode D in the phase control array 3C of FIG. 11 is replaced with a variable capacitor C.

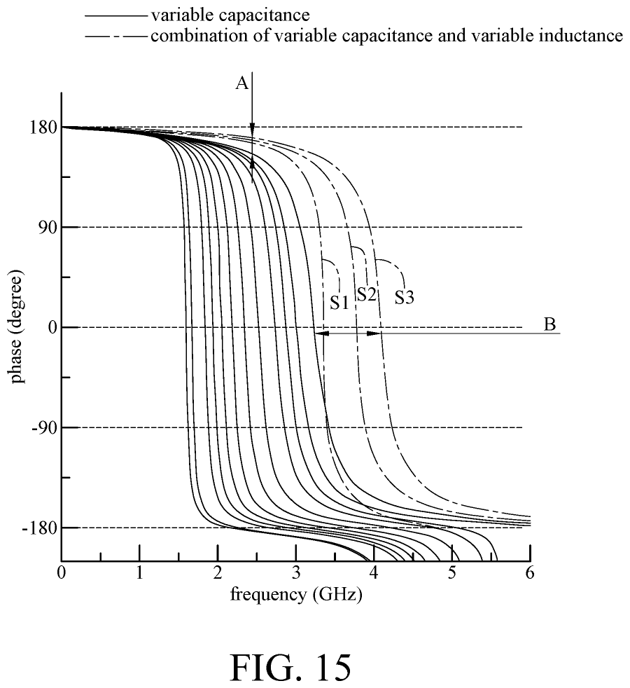

FIG. 15 is a diagram illustrating the relationship between phase and frequency of an embodiment of the phase control structure. As shown in FIG. 15, under a range of frequency operating, when the phase control structure is only equivalent to a variable capacitor structure, adjusting the variable capacitor to different capacitance values (for example, 0.1 pF˜3.0 pF) can respectively correspond to the solid line relationship curves of different phases and frequencies. Under the a same range of frequency operating, when the phase control structure has a combined structure which is equivalent to a variable capacitor and a variable inductor, in addition to the aforementioned solid line relationship curve of phase and frequency, the dotted line relationship curves of phase and frequency are added, for example, the dotted line relationship curves S1˜S3 of phase and frequency shown in FIG. 15. Therefore, under the same frequency operating range, when the phase control structure has a combined structure equivalent to a variable capacitor and a variable inductor, the increased phase range A is about 10%, and the increased bandwidth range B is about 26%.

The disclosed phase control structure and the phase control array of the present invention can determine whether or not the stub portion is electrically connected to the ground plate by controlling the switch connected between the stub portion and the ground plate to be in an on state or an off state. In this way, the inductance value of the phase control structure can be changed by controlling the state of the switch according to the application requirements. Compared with the adjustable surface impedance plane that can only control the capacitance value, the disclosed phase control structure and phase control array of the present invention can generate more combinations of resonance frequencies, as well as increasing the phase change range up to 360 degrees at the best, and increasing the bandwidth.

It will be apparent to those skilled in the art that various modifications and variations can be made to the phase control structure and the phase control array of the disclosed embodiments. It is intended that the specification and examples be considered as exemplars only, with a scope of the disclosure being indicated by the following claims and their equivalents.

What is claimed is:

1. A phase control structure, including:
a metal electrode plate including a first surface and a second surface;
a stub portion, wherein one end of the stub portion is connected to the second surface of the metal electrode plate;
a switch, wherein one end of the switch is connected to another end of the stub portion; and
a ground plate, wherein the ground plate is connected to another end of the switch;
wherein the metal electrode plate and the ground plate are disposed on a top surface and a bottom surface of a substrate respectively, the substrate is disposed with a via hole extending from the top surface of the substrate to the bottom surface of the ground plate, the second surface of the metal electrode plate contacts the top surface of the substrate, the stub portion is disposed in the via hole without contacting the ground plate; and
wherein the switch is used for receiving a control signal to be one of an on state and an off state.

2. The phase control structure in claim 1, wherein the switch includes a control terminal, an input terminal and an output terminal, the control terminal is used to receive the control signal, the input terminal is connected to the stub portion, and the output terminal is connected to the ground plate.

3. The phase control structure in claim 1, wherein the stub portion is a first stub portion, the switch is a first switch, and the phase control structure further includes a second stub portion, a third stub portion, a second switch, and a third switch; the second stub portion is spaced apart from the first stub portion and the third stub portion along a direction, and the second stub portion is located between the first stub portion and the third stub portion, two opposite ends of the second stub portion are respectively connected to the metal electrode plate and one end of the second switch, another end of the second switch is connected to the ground plate, and two opposite ends of the third stub portion are respectively connected to the metal electrode plate and one end of the third switch, and another end of the third switch is connected to the ground plate.

4. The phase control structure in claim 3, wherein the direction is a first direction, the phase control structure further includes a fourth stub portion, a fifth stub portion, a fourth switch and a fifth switch, the fourth stub portion is spaced apart from the second stub portion and the fifth stub portion along a second direction, the second direction is perpendicular to the first direction, and the second stub portion is located between the fourth stub portion and the fifth stub portion, two opposite ends of the fourth stub portion are respectively connected to the metal electrode plate and one end of the fourth switch, another end of the fourth switch is connected to the ground plate, two opposite ends of the fifth stub portion are respectively connected to the metal electrode plate and one end of the fifth switch, and another end of the fifth switch is connected to the ground plate.

5. A phase control array, including:
a plurality of phase control structures, wherein each phase control structure includes a metal electrode plate, a stub portion, a switch and a ground plate; the metal electrode plate includes a first surface and a second surface, one end of the stub portion is connected to the second surface, another end of the stub portion is connected to one end of the switch, and another end of the switch is connected to the ground plate;
wherein the metal electrode plate and the ground plate are disposed on a top surface and a bottom surface of a substrate respectively, the substrate is disposed with a via hole extending from the top surface of the substrate to the bottom surface of the ground plate, the second surface of the metal electrode plate contacts the top surface of the substrate, and the stub portion is disposed in the via hole without contacting the ground plate;
wherein the switch is used for receiving a control signal to be one of an on state and an off state, and a plurality of metal electrode plates of the plurality of phase control structures are spaced apart from each other; and
a plurality of diodes, wherein each diode is connected between any two adjacent metal electrode plates of the plurality of metal electrode plates.

6. The phase control array in claim 5, wherein the switch includes a control terminal, an input terminal and an output terminal, the control terminal is used to receive the control signal, the input terminal is connected to the stub portion, and the output terminal is connected to the ground plate.

7. The phase control array in claim 5, wherein the stub portion is a first stub portion, the switch is a first switch, and the phase control structure further includes a second stub portion, a third stub portion, and a second switch and a third switch, the second stub portion is spaced apart from the first stub portion and the third stub portion along a direction, and the second stub portion is located between the first stub portion and the third stub portion, two opposite ends of the second stub portion are respectively connected to the metal electrode plate and one end of the second switch, and another end of the second switch is connected to the ground plate, two opposite ends of the third stub portion are respectively connected to the metal electrode plate and one end of the third switch, and another end of the third switch is connected to the ground plate.

8. The phase control array in claim 7, wherein the direction is a first direction, and each phase control structure further includes a fourth stub portion, a fifth stub portion, a fourth switch and a fifth switch, the fourth stub portion is spaced apart from the second stub portion and the fifth stub portion along a second direction, the second direction is perpendicular to the first direction, and the second stub portion is located between the fourth stub portion and the fifth stub portion, two opposite ends of the fourth stub portion are respectively connected to the metal electrode plate and one end of the fourth switch, another end of the fourth switch is connected to the ground plate, two opposite ends of the fifth stub portion are respectively connected to the metal electrode plate and one end of the fifth switch, and another end of the fifth switch is connected to the ground plate.

9. A phase control array, including:
a plurality of phase control structures, wherein each phase control structure includes a metal electrode plate, a stub portion, a switch, and a ground plate, the metal electrode plate includes a first surface and a second surface, one end of the stub portion is connected to the second surface, another end of the stub portion is connected to one end of the switch, and another end of the switch is connected to the ground plate;
wherein the metal electrode plate and the ground plate are disposed on a top surface and a bottom surface of a substrate respectively, the substrate is disposed with a via hole extending from the top surface of the substrate to the bottom surface of the ground plate, the second surface of the metal electrode plate contacts the top surface of the substrate, and the stub portion is disposed in the via hole without contacting the ground plate;
wherein the switch is used for receiving a control signal to be one of an on state and an off state, and a plurality of metal electrode plates of the plurality of phase control structures are spaced apart from each other; and
a plurality of variable capacitors, wherein each variable capacitor is connected between any two adjacent metal electrode plates of the plurality of metal electrode plates.

10. The phase control array in claim 9, wherein the switch includes a control terminal, an input terminal and an output terminal, the control terminal is used to receive the control signal, the input terminal is connected to the stub portion, and the output terminal is connected to the ground plate.

11. The phase control array in claim 9, wherein each stub portion is a first stub portion, the switch is a first switch, and the phase control structure further includes a second stub portion, a third stub portion, and a second switch and a third switch, the second stub portion is spaced apart from the first stub portion and the third stub portion along a direction, and the second stub portion is located between the first stub portion, two opposite ends of the second stub portion are respectively connected to the metal electrode plate and one end of the second switch, and another end of the second switch is connected to the ground plate, two opposite ends of the third stub portion are respectively connected to the metal electrode plate and one end of the third switch, and another end of the third switch is connected to the ground plate.

12. The phase control array in claim 11, wherein the direction is a first direction, and the phase control structure further includes a fourth stub portion, a fifth stub portion, a fourth switch and a fifth switch, the fourth stub portion is spaced apart from the first stub portion and the fifth stub portion along a second direction, the second direction is perpendicular to the first direction, and the second stub portion is located between the fourth stub portion and the fifth stub portion, two opposite ends of the fourth stub portion are respectively connected to the metal electrode plate and one end of the fourth switch, another end of the fourth switch is connected to the ground plate, two opposite ends of the fifth stub portion are respectively connected to the metal electrode plate and one end of the fifth switch, and another end of the fifth switch is connected to the ground plate.
